(19) United States
(12) Patent Application Publication
(10) Pub. No.: US 2025/0366631 A1
(43) Pub. Date: Dec. 4, 2025

(54) PACKET DISPENSER

(71) Applicant: Becton, Dickinson and Company, Franklin Lakes, NJ (US)

(72) Inventors: Rahul Rajan Puthukkad, Bengaluru (IN); Supradeep Vankayala, Bangalore (IN); Hariharan Iyer, Franklin Lakes, NJ (US)

(21) Appl. No.: 19/297,877

(22) Filed: Aug. 12, 2025

Related U.S. Application Data
(63) Continuation of application No. PCT/US2023/064648, filed on Mar. 17, 2023.

(51) Int. Cl. A47F 1/10

(52) U.S. Cl. CPC A47F 1/10

(57) ABSTRACT

Packet dispensers disclosed herein can include a feeder disposed within a housing, the feeder configured to hold a plurality of packets. The feeder can include a receiving end configured to receive the plurality of packets and a dispensing end disposed below the receiving end, the dispensing end including an opening extending through the housing. A cutting mechanism can be disposed at least partially within the opening such that the cutting mechanism cuts individual packets as the individual packets are removed from the dispensing end of the feeder.

### CROSS-REFERENCE TO RELATED APPLICATIONS

The present application is a continuation of International Patent Application No. PCT/US2023/064648, filed Mar. 17, 2023, titled “PACKET DISPENSER”, the entire contents of which is incorporated by reference herein and forms a part of this specification for all purposes.

### FIELD

The present disclosure relates to packet dispensers, and more specifically to packet dispensers that allow a user to use one hand to dispense and open a packet.

### BACKGROUND

Packets storing items are frequently stored in drawers or other types of storage spaces. In order to gain access to the items stored within the packets, a user needs to locate or identify the storage space and then find the packet within the storage space. The user then typically needs to use both hands to open the packet and access the item stored within the packet. This can create challenges during an emergent situation, such as in medical settings when a user needs to open a packeted item, such as a syringe or a specimen collection item. For example, the amount of time and dexterity it takes to access and open a packet may distract a user from other important tasks. In some cases, users may try to overcome these difficulties by opening packets using one hand and their teeth. However, this workaround may be undesirable in the case of packets containing sterile items, as contamination may occur to the item being stored within the packet.

### SUMMARY

The embodiments disclosed herein each have several aspects no single one of which is solely responsible for the disclosure's desirable attributes. Without limiting the scope of this disclosure, its more prominent features will now be briefly discussed. After considering this discussion, and particularly after reading the section entitled “Detailed Description,” one will understand how the features of the embodiments described herein provide advantages over existing systems, devices, and methods related to packet dispensers.

The following disclosure describes non-limiting examples of some embodiments. For instance, other embodiments of the disclosed systems and methods may or may not include the features described herein. Moreover, disclosed advantages and benefits may apply only to certain embodiments of the disclosure and should not be used to limit the disclosure.

In one aspect, a packet dispenser includes a feeder and a first cutting mechanism. The feeder is disposed within a housing. The feeder is configured to hold a plurality of packets. The feeder includes a receiving end and a dispensing end. The receiving end is configured to receive the plurality of packets. The dispensing end is disposed below the receiving end. The dispensing end includes an opening extending through the housing. The first cutting mechanism is disposed at least partially within the opening. The first cutting mechanism is disposed at least partially within the opening. The first cutting mechanism is configured to cut individual packets of the plurality of packets as the individual packets are removed from the dispensing end of the feeder.

Various embodiments of the various aspects may be implemented. In some embodiments, the first cutting mechanism includes a first protrusion having a sharp edge and a second protrusion having a sharp edge. A first end of each individual packet is configured to pass between the first protrusion and the second protrusion when the individual packet is removed from the dispensing end of the feeder.

In some embodiments, the packet dispenser further includes a second cutting mechanism positioned at an opposite end of the opening relative to the first cutting mechanism.

In some embodiments, the packet dispenser further includes a shuffler configured to shuffle the plurality of packets within the feeder. The shuffling of the plurality of packets assists at least one of the plurality of packets to move toward the dispensing end.

In some embodiments, the shuffler includes a button disposed at an exterior of the housing and mechanically linked to at least one actuator within the feeder.

In some embodiments, depressing the button causes the at least one actuator to lift one or more other packets within the feeder to allow the at least one of the plurality of packets to move toward the dispensing end.

In some embodiments, the receiving end of the feeder includes an opening having a length greater than or equal to a length of each individual packet and a width shorter than the length of each individual packet.

In some embodiments, the packet dispenser further includes a waste drawer configured to receive a portion of the packet removed when the first cutting mechanism opens one of the plurality of packets.

In some embodiments, the opening of the dispensing end has a recessed area positioned between two lateral ends, wherein the first cutting mechanism is disposed within one of the lateral ends.

In some embodiments, the packet dispenser further includes a second feeder and a second cutting mechanism. The second feeder is disposed within the housing. The second feeder is configured to hold a second plurality of packets. The second feeder includes a receiving end and a dispensing end. The receiving end is configured to receive the second plurality of packets. The dispensing end is disposed below the receiving end. The dispensing end includes a second opening extending through the housing. The second cutting mechanism is disposed at least partially within the second opening. The second cutting mechanism is configured to open individual packets of the second plurality of packets as the individual packets are removed from the dispensing end of the second feeder.

In another aspect, a packet dispenser includes a feeder, a first cutting mechanism, and a second cutting mechanism. The feeder is disposed within a housing. The feeder is configured to receive a plurality of packets in a predetermined orientation and feed the plurality of packets toward a dispensing end of the feeder. The first cutting mechanism and the second cutting mechanism are disposed within an opening of the dispensing end of the feeder. The first cutting mechanism is positioned at an opposite end of the opening relative to the second cutting mechanism. The first cutting mechanism is configured to cut a first end of individual packets of the plurality of packets as the individual packets are removed from the dispensing end of the feeder. The second cutting mechanism is configured to cut a second end of the individual packets of the plurality of packets as the individual packets are removed from the dispensing end of the feeder.

Various embodiments of the various aspects may be implemented. In some embodiments, the opening of the dispensing end has a recessed area positioned between two lateral ends, wherein the first cutting mechanism is disposed within a first of the lateral ends and the second cutting mechanism is disposed within a second of the lateral ends.

In some embodiments, the first cutting mechanism includes a first protrusion having a sharp edge and a second protrusion having a sharp edge. The first end of each individual packet of the plurality of packets is configured to pass between the first protrusion and the second protrusion when the individual packet is removed from the dispensing end.

In some embodiments, the second cutting mechanism includes a first protrusion having a sharp edge and a second protrusion having a sharp edge. The second end of each individual packet of the plurality of packets is configured to pass between the first protrusion and the second protrusion when the individual packet is removed from the dispensing end.

In some embodiments, the packet dispenser further includes a shuffler configured to shuffle the plurality of packets within the feeder, wherein the shuffling of the plurality of packets assists at least one of the plurality of packets to move toward the dispensing end.

In some embodiments, the shuffler includes a button disposed at an exterior of the housing and mechanically linked to at least one moveable component within the feeder.

In some embodiments, depressing the button causes the at least one moveable component to lift one or more other packets within the feeder to allow the at least one of the plurality of packets to move toward the dispensing end.

In some embodiments, a receiving end of the feeder includes an opening having a length greater than or equal to a length of each individual packet and a width shorter than the length of each individual packet.

In some embodiments, the packet dispenser further includes a first waste drawer configured to receive a first portion of the individual packet removed when the first cutting mechanism opens the first end of the individual packets of the plurality of packets and a second waste drawer configured to receive a second portion the individual packet removed when the second cutting mechanism opens the second end of the individual packets of the plurality of packets. In some embodiments, the plurality of packets each contain a sterilized item

In another aspect, a method of dispensing a packet includes directing a plurality of packets to a dispensing end of a packet dispenser by receiving the plurality of packets into a feeder positioned in a housing of the packet dispenser. The plurality of packets move from a receiving end of the feeder to the dispensing end of the feeder. The method also includes exposing a portion of one of the plurality of packets extending at least partially out of an opening at the dispensing end of the feeder. The method also includes cutting at least one end of the one of the plurality of packets as the at least one end passes through a cutting mechanism disposed within the opening of the dispensing end.

Various embodiments of the various aspects may be implemented. In some embodiments, the method includes shuffling the plurality of packets within the feeder in response to a button coupled to a shuffler disposed within the housing being depressed.

In some embodiments, the method includes cutting a second end of the one of the plurality of packets as the second end passes through a cutting mechanism disposed within the opening of the dispensing end.

In some embodiments, directing the plurality of packets to the dispensing end further comprises constraining the plurality of packets to a first orientation configured to align with an opening of the receiving end.

### BRIEF DESCRIPTION OF THE DRAWINGS

The above-mentioned aspects, as well as other features, aspects, and advantages of embodiments of the present disclosure will now be described in connection with various implementations, with reference to the accompanying drawings. The illustrated implementations are merely examples and are not intended to be limiting. Throughout the drawings, similar symbols typically identify similar components, unless context dictates otherwise.

FIG. 1 is a perspective view of an example packet dispenser in accordance with the present disclosure.

FIG. 2 is a cross-sectional side view of the packet dispenser of FIG. 1.

FIG. 3A is a front view of a dispensing end and cutting mechanism of the of the packet dispenser of FIG. 1.

FIG. 3B is a schematic front view of the cutting mechanism of FIG. 3A.

FIG. 4 is a perspective view of a top portion of the packet dispenser of FIG. 1 illustrating a lid or cover detached from the packet dispenser.

FIG. 5 is a perspective view of an example feeder for a packet dispenser in accordance with the present disclosure.

FIGS. 6A-6C are schematic side views of an example feeder and shuffler illustrating the operation of a shuffler in accordance with the present disclosure.

FIG. 7 is a cross-sectional side view of the dispensing end of a packet dispenser in accordance with the present disclosure.

FIG. 8A is a flow chart illustrating an example method of using a packet dispenser in accordance with the present disclosure.

FIG. 8B is a flow chart illustrating an example method of dispensing a packet in accordance with the present disclosure.

FIG. 9 illustrates an example method of using a packet dispenser in accordance with the present disclosure to dispense packets containing syringes.

FIG. 10A is an example packet dispenser configured to dispense multiple types of packets in accordance with the present disclosure.

FIG. 10B is a top perspective view of the packet dispenser of FIG. 10A with a lid or cover detached from the packet dispenser.

FIG. 10C is a cross-sectional side view of the packet dispenser of FIG. 10A.

FIG. 11 illustrates an example modular configuration of a plurality of packet dispensers in accordance with the present disclosure.

### DETAILED DESCRIPTION

Packets can be used to store various types of items, one non-limiting example being sterile medical equipment such as but not limited to syringes, specimen collection swabs, specimen collection cups, sample tubes, blood collection vials, and other fluid vials. For instance, sealed packets are frequently used in medical environments or trauma areas, such as hospitals, ambulances, and other medical facilities. The packets can be sealed and therefore require a user to use both hands to open the packet in order to gain access to the item stored within the packet. In emergent situations, such as medical emergencies, a user may not have the ability to use both hands to open a packet, as they may need one of their hands to perform another task, for example, while transferring a patient in an ambulance a medical professional may need one hand to apply pressure to a wound on a patient. In these situations, users may try to open a packet with one hand, with a combination of one hand and the user's teeth, or in other ways that are inefficient and may increase the probability of damage or contamination of the item within the packet.

Embodiments of the present disclosure relate to packet dispensers. In particular, the disclosure relates to packet dispensers that facilitate one-handed retrieval and opening of packets from the packet dispenser. Some embodiments include dispensers configured to cut open packets as they are dispensed from the packet dispenser. The packet dispensers can open packets at one or both ends of the packet as a user pulls the packet out of a dispensing end of the packet dispenser. One or more cutting mechanisms disposed at the dispensing end of the packet dispenser can cut open the packets. By opening packets as they are dispensed from the packet dispenser, a user will have immediate or nearly immediate access to the item being stored within the packet. The user will also be able to access the item with the use of only hand. Single hand operation to open a packet can provide an easy and fast access to the item stored within the packet and allow the other hand to be used for another task at the same time. Single hand operation can also decrease the likelihood that a user will use their teeth or an unsterilized object, such as unsterilized scissors, to attempt to open a packet, thereby decreasing the chance of contaminating the item stored within the packet.

In some embodiments, the dispensing end of the packet dispensers can include an opening having a recessed area and lateral ends positioned on each side of the recessed area. The cutting mechanisms can be positioned within the lateral ends. The lateral ends can be narrower than the recessed area which can function as a safety feature by preventing a user's fingers from contacting the cutting mechanisms while retrieving a packet.

### Example Packet Dispenser

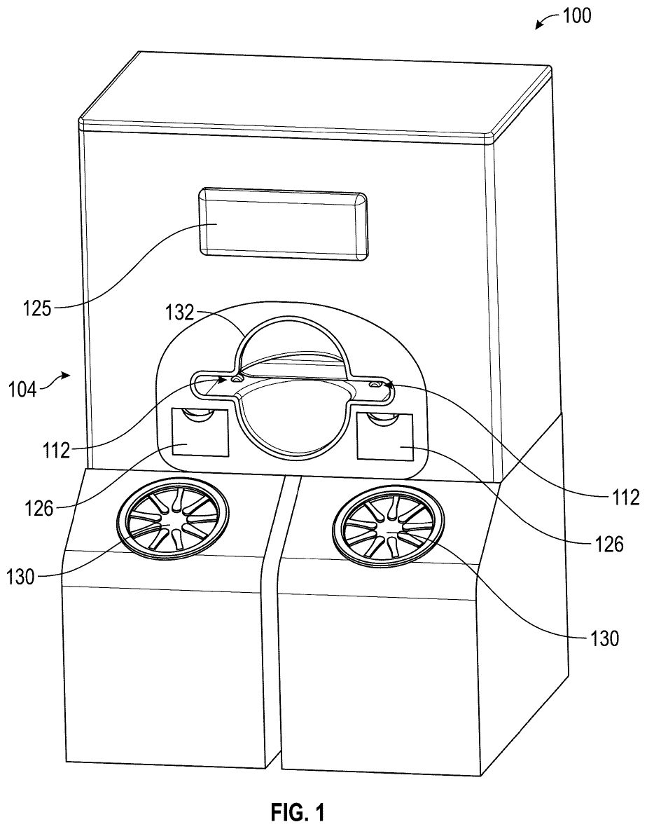

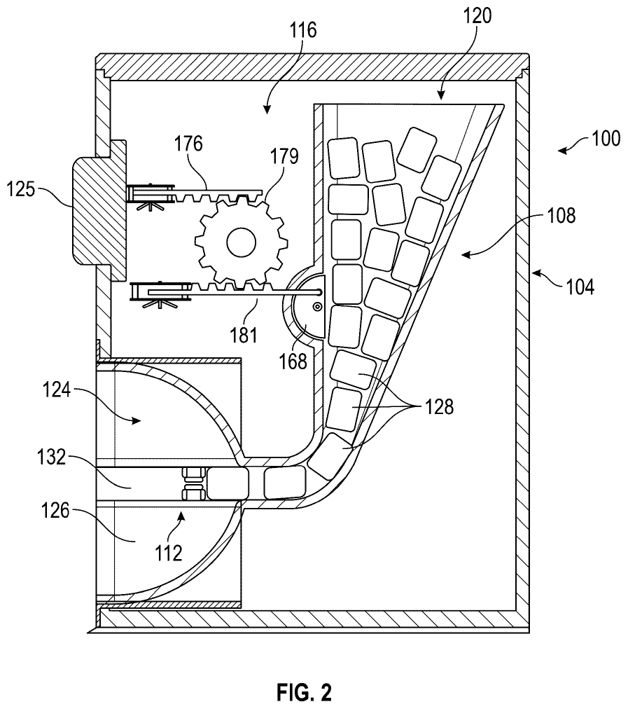

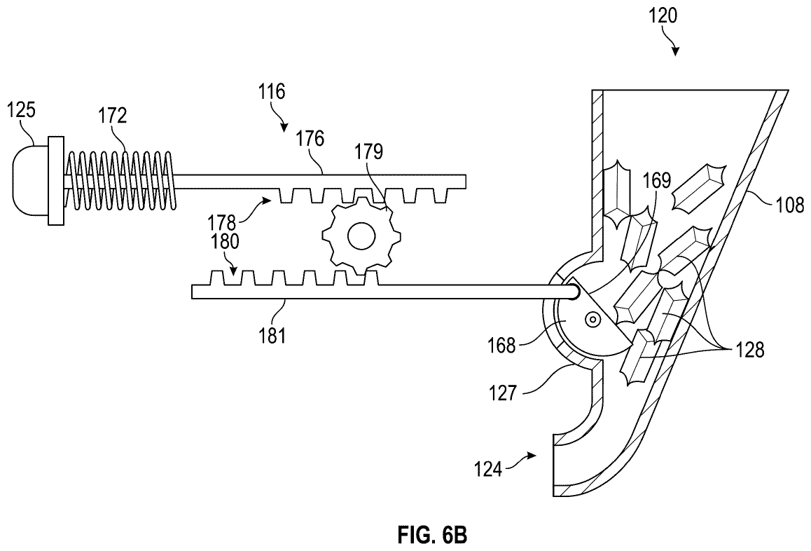

FIGS. 1 and 2 illustrate a packet dispenser 100 in accordance with one non-limiting embodiment of the present disclosure. The packet dispenser 100 can include a housing 104, a feeder 108, and one or more cutting mechanism 112. In some embodiments, the packet dispenser 100 can include a shuffler 116. The feeder 108 can have a receiving end 120 and a dispensing end 124. One or more packets 128 can be inserted into the receiving end 120 of the feeder 108. The packets 128 can be stored within the feeder 108 until each packet 128 travels to the dispensing end 124 of the feeder 108 to be dispensed from the packet dispenser 100. The shuffler 116 can be used to shuffle the one or more packets 128 within the feeder 108, such as to assist in realigning the packets 128 to clear a blockage or jam of packets 128 within the feeder 108. A button 125 extending through the housing 104 can be provided to actuate the shuffler 116, which is described in more detail with reference to FIGS. 6A-6C.

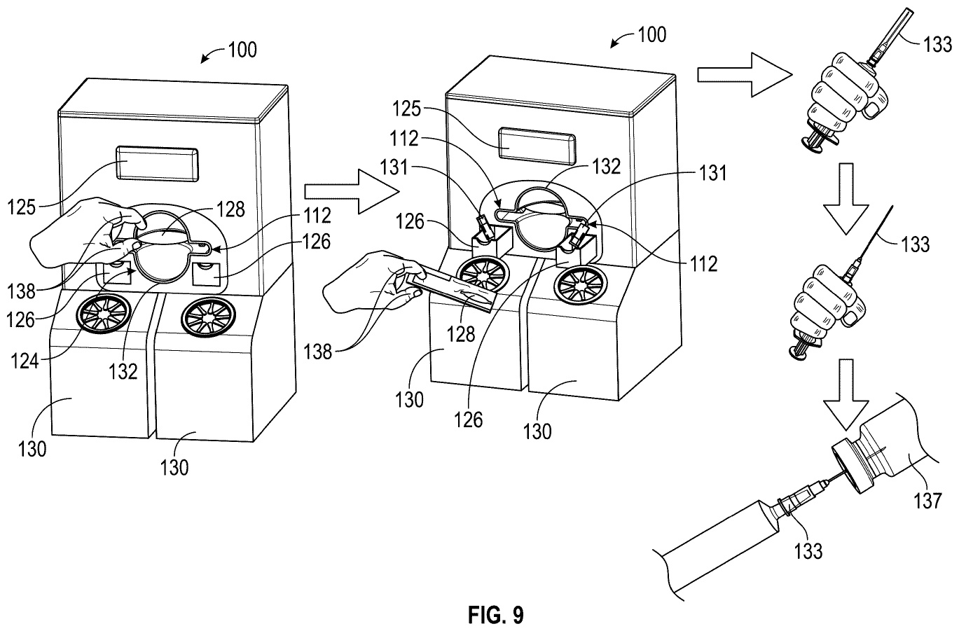

In some embodiments, the packet dispenser 100 can include one or more scrap containers 126 positioned below the one or more cutting mechanisms 112 to collect portions of the packets 128 that are cut off when the packets 128 are dispensed from the packet dispenser 100 (as shown in FIG. 9). The one or more scrap containers 126 can function like drawers by moving in and out of the housing 104 to allow for a user to empty the portions of the packets 128 that are collected in the scrap containers 126.

In some embodiments, the packet dispenser 100 can include one or more waste containers 130. The waste containers 130 can be used to store and/or dispose of items removed from the packets 128 after the items are used. In one non-limiting example, the waste containers 130 can be sharp collectors for collecting used syringes that are dispensed using the packet dispenser 100. The inclusion of the waste containers 130 may provide a complete end-to-end usage support for single-use devices, such as syringes and specimen collection items, with the waste container 130 being available for disposal of the used devices and any remaining packaging.

The dispensing end 124 of the feeder 108 can include an opening 132 which can extend through the housing 104. The opening 132 can be large enough that one of the packets 128 is visible to a user for removal from the dispensing end 124, and large enough to accommodate a user's fingers as the user reaches into the opening 132 to grasp the next available packet 128.

### Example Cutting Mechanism

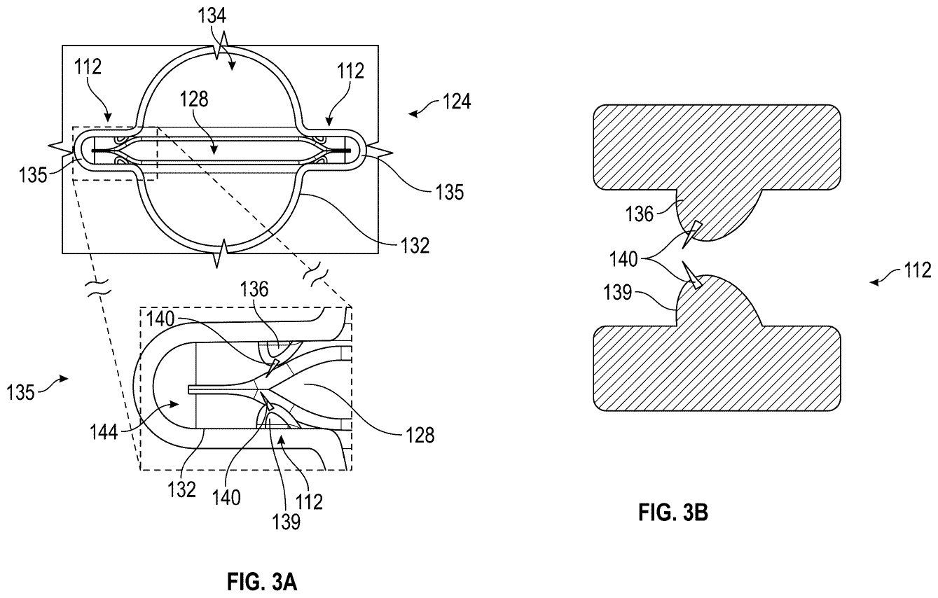

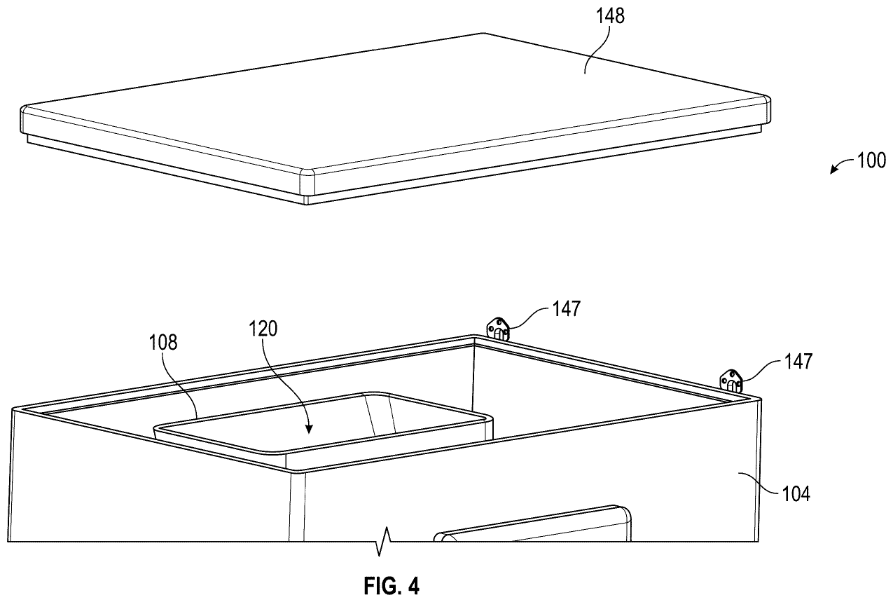

FIGS. 3A and 3B illustrate the opening 132 and the one or more cutting mechanisms 112. The opening 132 can have a recessed area 134 and one or more lateral ends 135. The one or more cutting mechanism 112 can be disposed at least partially within the opening 132. In some embodiments, the packet dispenser 100 can include two cutting mechanisms 112. The first cutting mechanism 112 can be positioned at an opposite end of the opening 132 relative to the second cutting mechanism 112. In some embodiments, the one or more cutting mechanisms 112 can be positioned at the lateral ends 135 of the opening 132. The one or more cutting mechanisms 112 being positioned in the lateral ends 135 of the opening 132 can protect a user's fingers and/or hand from coming into contact with the one or more cutting mechanisms 112. The user is able to grasp the packet 128 by reaching into the recessed area 134 of the opening 132 without the need to reach into the lateral ends 135 of the opening 132.

The recessed area 134 may be large enough to accommodate one or two fingers above and below a packet 128 positioned in the opening 132. The size of the recessed area 134 can allow for easy access to a middle section of the packet 128. In some embodiments, the lateral ends 135 of the opening 132 are shaped and sized to prevent a user from inserting a finger or a hand in the lateral ends 135, without restricting a cutting action of the one or more cutting mechanism 112. The lateral ends 135 can be narrower than the recessed area 134 such that the user's fingers are prevented from reaching into the lateral ends 135 and coming into contact with the one or more cutting mechanisms 112. The relative sizing of the recessed area 134 and the lateral ends 135 can function as a safety mechanism preventing injury when the packet dispenser 100 is used in a fast-paced situation or environment.

In some embodiments, each cutting mechanism 112 can include a first protrusion 136 positioned opposite a second protrusion 139. One or both of the protrusions 136, 139 can have a sharp edge 140 capable of cutting through the packets 128. In some embodiments, the protrusions 136, 139 themselves can be sharp. In some embodiments, separate sharp edge pieces can be coupled to the protrusions 136, 139. In some embodiments, the sharp edges 140 can be blades extending from each protrusion 136, 139. The blades or sharp edges 140 can be a removable and/or replaceable part. This can allow for the blades or sharp edges 140 to be replaced or repaired after they lose their sharpness or if they break. In some embodiments, each cutting mechanism 112 can be provided in the form of a cartridge which can be attached and detached within the opening 132 for removal and replacement if the sharp edges 140 become dull or broken.

The opposing protrusions 136, 139 can be positioned opposite one another such that a portion of each packet 128 being dispensed from the packet dispenser 100 passes between the opposing protrusions 136, 139 and sharp edges 140. For example, a first end 144 of an individual packet 128 can be cut off by the cutting mechanism 112, as it passes through the cutting mechanism 112 as shown in FIG. 3A. In various embodiments, the sharp edges 140 of each cutting mechanism 112 can be directly opposed or may be laterally offset from each other, with the specific configuration being selectable based on the type and material of packet being dispensed.

### Example Housing and Packet Feeder

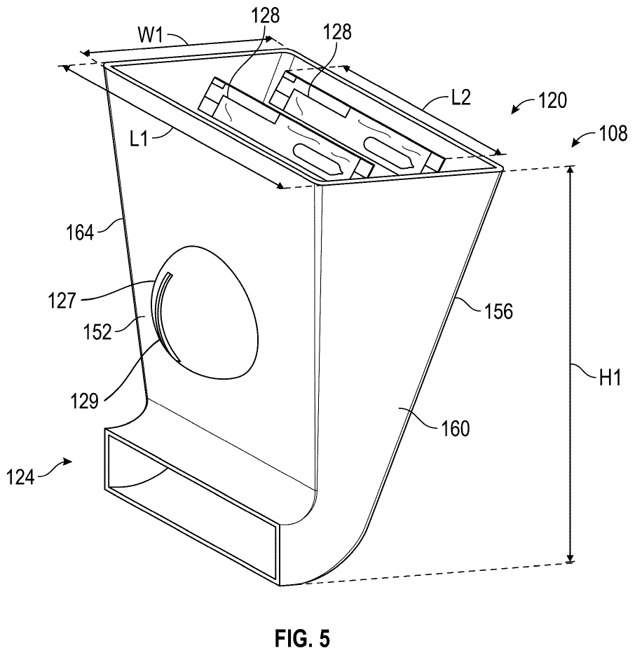

As shown in FIG. 4, the housing 104 of the packet dispenser 100 can include a removable lid 148 or cover. The lid 148 can be removed from the housing 104 to provide access to the receiving end 120 of the feeder 108. The packets 128 can then be placed into the feeder 108 through the receiving end 120. In some embodiments, the lid 148 can be coupled to the housing 104 by one or more hinges 147. The lid 148 can than be rotated about the hinges 147 to open and close the lid 148.

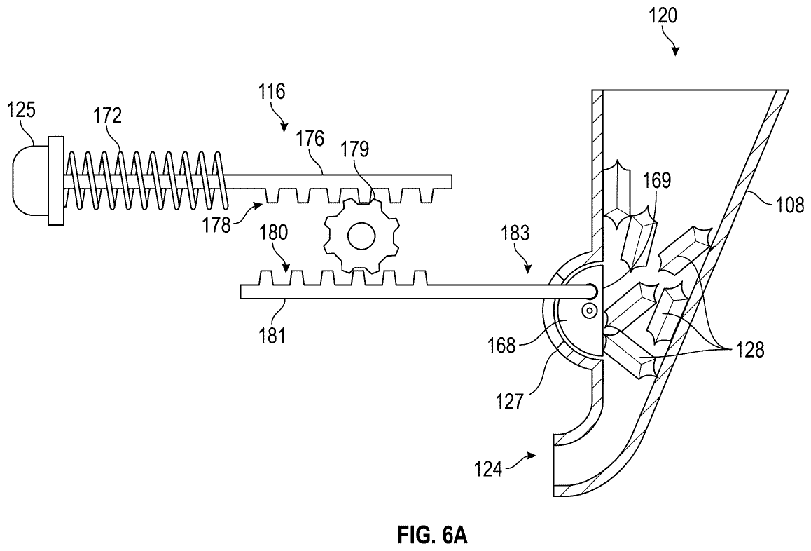

FIG. 5 illustrates an example feeder 108 in accordance with the present disclosure. In some embodiments, the receiving end 120 of the feeder 108 can be sized and shaped to allow for the packets 128 to be placed within the receiving end 120 of the feeder 108 in a predetermined orientation. The receiving end 120 can have a length L1 and a width W1. An individual packet 128 can have a length L2 and a width W2. The length L1 of the receiving end 120 can be greater than or equal to a length L2 of each individual packet 128. The width W1 of the receiving end 120 can be shorter than the length L2 of each individual packet 128. The length L1 being greater than or equal to the length L2 of each individual packet 128, and the width W1 of the receiving end 120 being shorter than the length L2 of each individual packet 128, can constrain the orientation of the packets 128 when placed into the feeder 108. For example, the length L1 of the receiving end 120 and the length L2 of the packet 128 can be aligned generally parallel to allow for insertion of the packet 128. If the length L2 of the packet 128 were to be aligned generally parallel to the width W1 of the receiving end 120, the packet 128 would not be able to be placed within the feeder 108. This can be advantageous in that it can increase the probability the packets 128 will be positioned within the feeder 108 in an orientation that allows the packets 128 to eventually travel to the dispensing end 124 of the feeder 108 and to be cut by the cutting mechanism as they are removed from the dispensing end 124.

A relatively large opening at the receiving end 120 of the feeder can facilitate loading of packets 128 and can provide a greater volume for packet storage within the feeder. However, a relatively narrow opening at the dispensing end 124 of the feeder 108 may be desirable in order to singulate the packets for individual dispensing, and to ensure that each packet is aligned with the cutting mechanism(s). Accordingly, in some embodiments, the feeder 108 can be generally funnel-shaped, with the width W1 and/or the length L1 of the feeder 108 decreasing along the height H1 of the feeder 108 from the receiving end 120 to the dispensing end 124. In some embodiments, a first wall 152 of the feeder 108 can taper inward, causing the width W1 to decrease along the height H1 of the feeder from the receiving end 120 to the dispensing end 124, for example, the width at the receiving end 120 can be larger than the width at the dispensing end 124. In some embodiments, a second wall 156 can taper inward, causing the width W1 to decrease along the height H1 of the feeder from the receiving end 120 to the dispensing end 124, for example, the width at the receiving end 120 can be larger than the width at the dispensing end 124. In some embodiments, the first wall 152 and the second wall 156 can both taper inward causing the width W1 to decrease as the feeder 108 extends from the receiving end 120 to the dispensing end 124. In some embodiments, the length L1 of the feeder 108 can decrease along the height H1 of the feeder 108 from the receiving end 120 to the dispensing end 124. In some embodiments, a first sidewall 160 can taper inward causing the length L1 to decrease as the feeder 108 extends from the receiving end 120 to the dispensing end 124. In some embodiments, the first sidewall 160 and a second sidewall 164 can both taper inward causing the length L1 to decrease.

In some embodiments, one or more of the first wall 152, the second wall 156, the first sidewall 160, and the second sidewall 164 can be transparent. The transparency of the one or more walls can allow a user to easily check the fill level of the feeder 108.

### Example Shuffler and Dispensing End

FIGS. 6A-6C show the example feeder 108 of FIG. 5 and an example embodiment of the shuffler 116 with the housing 104 removed for illustrative purposes. In some cases, a jam or blockage of packets 128 may form as the width of the feeder 108 narrows, preventing packets 128 from traveling to the dispensing end 124 at the bottom of the feeder 108. An example jam or blockage of packets 128 is shown in FIG. 6A. The shuffler 116 can engage the feeder 108 to shuffle the plurality of packets 128 within the feeder 108. The shuffling of the plurality of packets 128 can break up such a blockage or jam to allow packets 128 to continue traveling to the dispensing end 124 of the feeder 108. As described above, the shuffler 116 can be operated through the use of the button 125. The button 125 can extend outside of the housing 104. The shuffler 116 can be mechanically linked to at least one moveable component such as an actuator 168. The actuator 168 can engage the packets 128 to shuffle the packets 128 within the feeder 108. The button 125 can be pushed or depressed by a user to cause the actuator 168 of the shuffler 116 to move. The mechanical linkage between the button 125 and the actuator 168 as shown in FIGS. 6A-6C is only a particular non-limiting example, and it will be understood that the button 125 may be linked to the actuator 168 using any other suitable mechanical or non-mechanical linkage (for example, using one or more electrical, mechanical, and/or electromechanical components) without departing from the scope of the present disclosure.

In some embodiments, the actuator 168 can be positioned outside the feeder 108 and contact outer walls of the feeder 108 to move the feeder and cause the packets 128 to move. In some embodiments, the actuator 168 can be disposed within the feeder 108 and directly contact the packets 128 to shuffle the packets 128 and cause the packets 128 to move toward the dispensing end 124 of the feeder 108. The actuator 168 can be positioned within a protrusion 127 of the wall 152. The protrusion 127 can include an opening 129 that a shaft 181 can extend through. The protrusion 127 can be sized and shaped to correspond to the size and shape of the actuator 168. In some embodiments, the actuator 168 can include a generally flat or slightly curved edge 169 configured to rotate or otherwise move at least partially into the space within the feeder 108 where packets 128 are located in response to the button 125 being pushed. The movement of the edge 169 of the actuator 168 can move one or more of the packets 128 to clear the blockage or jam. For example, the edge 169 may lift one or more packets 128 upward as the edge 169 moves, such that one or more other packets 128 can fall past the lifted packets 128 into the dispensing end 124, as illustrated sequentially in FIGS. 6A-6C.

The shuffler 116 can include a biasing member 172. In some embodiments, the biasing member 172 can be a spring disposed around a shaft 176. The biasing member 172 can compress as the button 125 is pushed and re-expands as the button 125 is released. In some embodiments, the shaft 176 can include tracks 178 configured to engage a gear 179. The gear 179 can be disposed between the tracks 178 of the shaft 176 and between tracks 180 of a shaft 181 that is coupled to the moveable component 168. The actuator 168 can be fixed to an end 183 of the shaft 181. As the shaft 181 translates or is pulled or pushed linearly, the actuator 168 rotates about its axis of rotation.

FIG. 6A illustrates the shuffler 116 in a disengaged configuration. The button 125 has not yet been pushed and the packets 128 are currently stored in a middle region of the feeder 108. The packets 128 have formed a jam or blockage that is preventing the packets 128 from moving to the dispensing end 124 of the packet dispenser 100. The gear 179 is positioned in a generally central position between the tracks 178, 180. FIG. 6B illustrates the shuffler 116 in an engaged configuration. The button 125 has been pushed and the biasing member 172 has compressed. The actuator 168 has rotated and shuffled the packets 128. Using the orientation of FIG. 6B as shown, the rightward motion of the shaft 176 causes clockwise rotation of the gear 179, which in turn causes leftward motion of the shaft 181. The motion of the shafts 176, 181 and rotation of the gear 179 causes counterclockwise rotation of the actuator 168. The rotation of the actuator 168 can lift and/or move some of the packets 128. As shown, in FIG. 6B, the packets 128 have started to change positions. FIG. 6C illustrates the shuffler 116 as it returns to a disengaged configuration. The button 125 is no longer being pushed and the biasing member 172 is re-expanding from the compressed configuration. Using the orientation of FIG. 6C as shown, the leftward motion of the shaft 176 causes counterclockwise rotation of the gear 179, which in turn causes rightward motion of the shaft 181. The motion of the shafts 176, 181 and rotation of the gear 179 causes clockwise rotation of the actuator 168, allowing the actuator 168 to return to the disengaged configuration. As the actuator 168 returns to the disengaged configuration, the packets 128 have been shuffled such that the jam or blockage is cleared and at least one of the packets 128 can travel to the dispensing end 124 of the feeder 108.

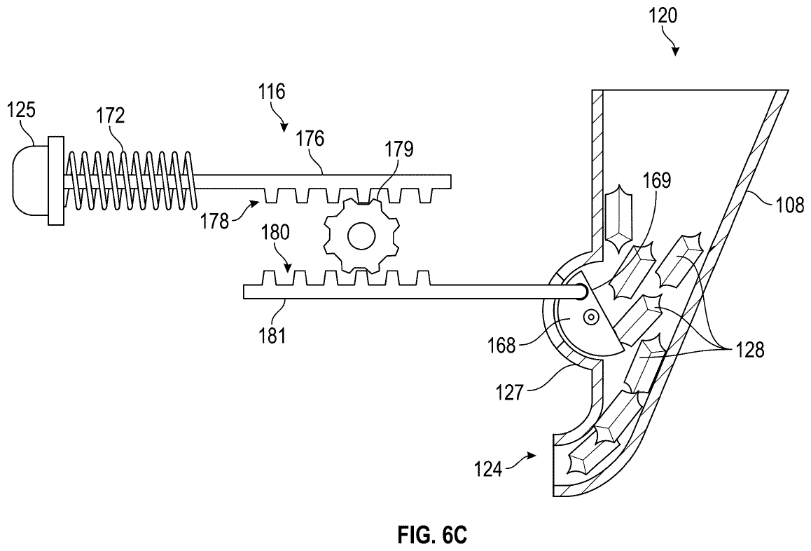

FIG. 7 is a side view of the dispensing end 124. As shown, packets 128 are traveling toward the opening 132 of the dispensing end 124. One packet 128 at a time can travel through the one or more cutting mechanisms 112 and out the opening 132. Ends 131 of the packets 128 can be removed by the one or more cutting mechanisms 112 and collected by the scrap container 126. As a first packet 128 is removed from the dispensing end 124, a second packet 128 takes the place of the first packet 128 in the opening 132 of the dispensing end 124 (for example, being pushed toward the opening 132 by other packets 128 above and behind the second packet 128 in the feeder) leaving the second packet 128 ready for immediate dispensing by the next user. In one non-limiting example, as the leftmost packet 128 illustrated in FIG. 7 is removed from the dispensing end 124, the rightmost packet 128 moves towards the opening 132, into position for removal. Force exerted by packets stored in the funnel 108 can cause the rightmost packet 128 to move toward the opening 132 as the leftmost packet 128 is removed from the dispensing end 124. At the same time, the one or more cutting mechanism(s) 112 can block unimpeded movement of the packets 128 out of the opening 132 due to force exerted by the packets stored in the funnel 108, such that an external force, such as a user grasping a packet 128 through the opening 132 and pulling the packet 128 through the one or more cutting mechanism(s) 112, can be required to dispense a packet 128.

### Example Packet Dispenser Workflows

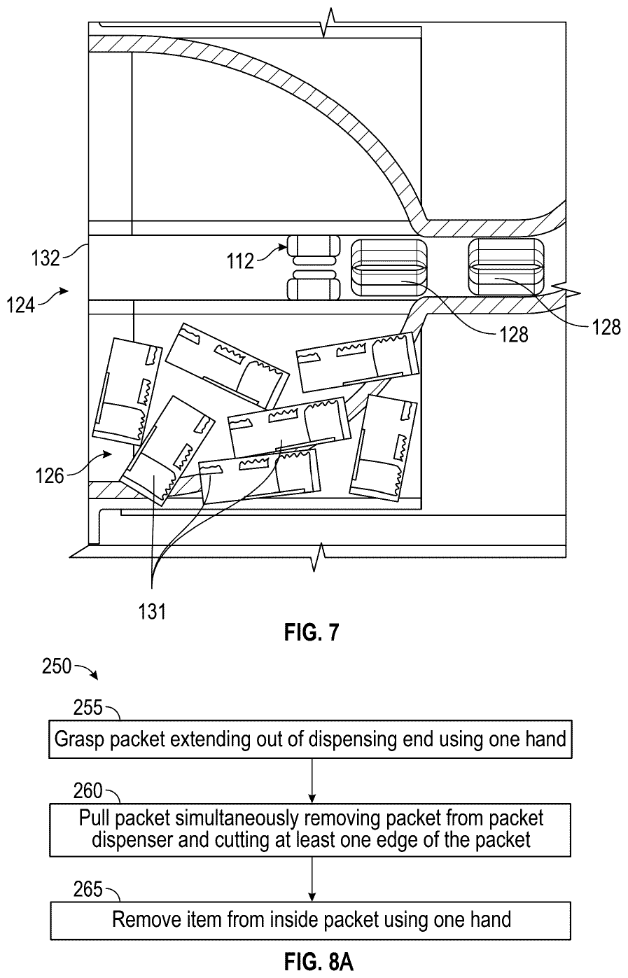

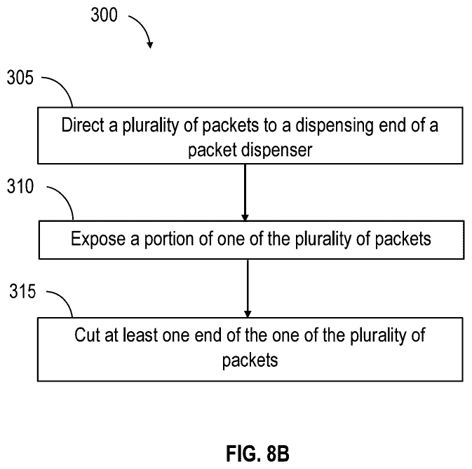

FIG. 8A is a flow chart showing an example embodiment of a method 250 of using a packet dispenser (for example, packet dispenser 100) according to the present disclosure. The method 250 can be performed by a user in conjunction with any packet dispenser in accordance with the present disclosure, such as the packet dispenser 100 as described herein. Throughout the discussion of FIG. 8A, reference will be made to elements illustrated in FIGS. 1 and 2.

The method 250 begins at block 255, with a user grasping a packet (for example, packet 128) at least partially extending out of an opening (for example, opening 132) of the dispensing end (for example, dispensing end 124) of the packet dispenser. The method 250 can then move to block 260, where the user can pull the packet from the packet dispenser. Advantageously, embodiments of the packet dispenser according to the present disclosure allow the user to pull the packet from the packet dispenser using a single hand. As the packet is pulled from the packet dispenser, at least one cutting mechanism (for example, cutting mechanism 112) can cut at least one edge of the packet. The cutting of the at least one edge of the packet can open the packet, allowing the user access to an item stored within the packet. The method 250 can then move to block 265, where the user can remove the item from the packet using one hand. The method 250 is advantageous as it allows for a user to use one hand to dispense and open a packet. Further, the method 250 advantageously condenses the steps of finding a packet, opening the packet, and taking out the item within the packet, into a single step where a user pulls the packet automatically positioned in the dispensing end out of the packet dispenser, where the step of pulling the packet out of the dispenser simultaneously cuts the ends of the packet, thereby allowing the item within the packet to fall out or be easily removed from the packet.

FIG. 8B is a flow chart showing an example embodiment of a method 300 of dispensing a packet (for example, by packet dispenser 100) according to the present disclosure. The method 300 can be performed by any packet dispenser in accordance with the present disclosure, such as the packet dispenser 100 as described herein. Throughout the discussion of FIG. 8B, reference will be made to elements illustrated in FIGS. 1 and 2.

The method 300 begins at block 305, with a plurality of packets (for example, packets 128) being directed to a dispensing end (for example, dispending end 124) of the packet dispenser. The plurality of packets can be directed to the dispensing end by receiving the plurality of packets into a feeder (for example, feeder 108) positioned in a housing (for example, housing 104) of the packet dispenser and allowing the plurality of packets to move from a receiving end of the feeder to the dispensing end of the feeder. The method 300 can then move to block 310, where a portion of one of the plurality of packets can be exposed. The portion of the one of the plurality of packets can be exposed by extending at least partially out of an opening (for example, opening 132) at the dispensing end of the feeder. The method 300 can then move to block 315 where at least one end of the one of the plurality of packets is cut. The at least one end of the one of the plurality of packets can be cut by as the at least one end passes through a cutting mechanism (for example, cutting mechanism 112) disposed within the opening of the dispensing end.

FIG. 9 illustrates a non-limiting example method of using a packet dispenser (for example, packet dispenser 100) according to the present disclosure. Specifically, FIG. 9 illustrates using the packet dispenser to dispense packets (for example, packets 128) containing syringes. While the items contained within the packets are depicted as syringes, the packet dispenser 100 and the method illustrated in FIG. 9 can be implemented with packets storing any type of item without departing from the scope of the present disclosure.

As shown in FIG. 9, a user can grasp the packet 128, with one hand, by inserting two or more fingers 138 into the opening 132 to grasp the middle of the packet 128 from the dispensing end 124 of the packet dispenser 100. The ends 131 of the packets 128 can pass through cutting mechanisms (for example, cutting mechanisms 112) as the user pulls the packet 128 through the opening (for example, opening 132) of the dispensing end 124. As the ends 131 of the packets 128 pass through the cutting mechanisms, the ends 131 can be cut off or separated from the remaining portion of the packet 128. The ends 131 can be collected by the scrap containers 126. The user can then remove a syringe 133 from the opened packet 128 using one hand. In some embodiments, the user can hold one end of the syringe and allow the remainder of the packet 128 to fall off to remove the syringe from the packet 128. The user's other hand can be completing another task while the user is removing the packet 128 from the packet dispenser 100, for example, the user can be tending to a patient or preparing a vial 137 for use with the syringe.

### Example Multi-feeder Packet Dispenser

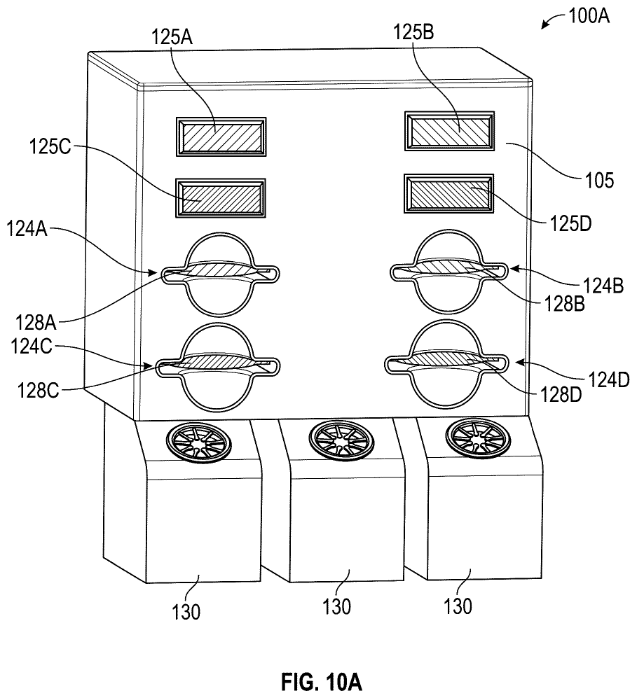

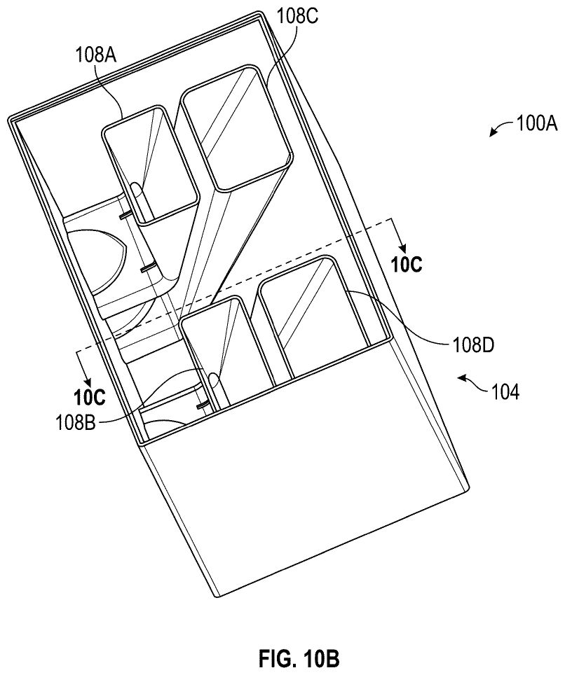

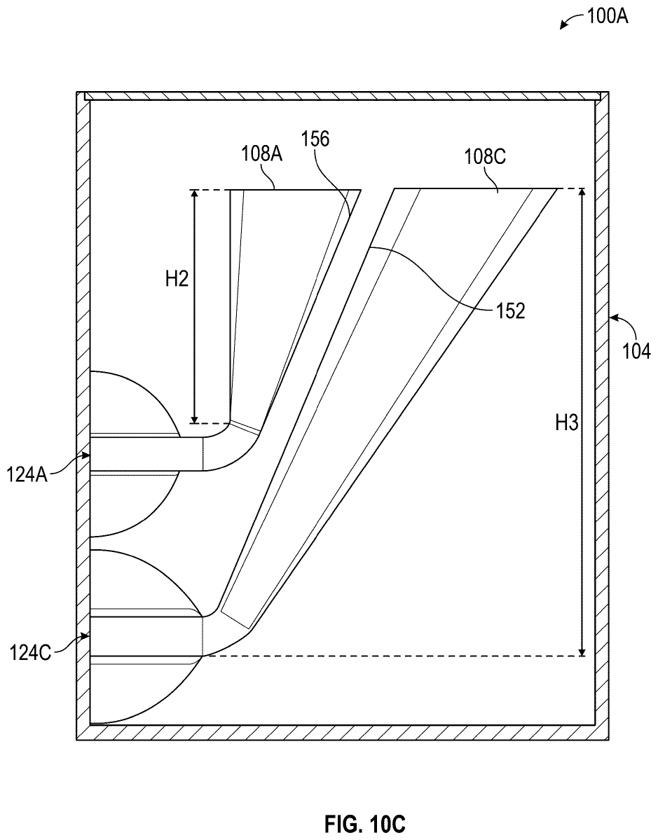

FIGS. 10A-10C show another example embodiment of a packet dispenser 100A according to the present disclosure. The packet dispenser 100A can include any of the features described herein with reference to packet dispenser 100. The packet dispenser 100A can be used to dispense one or more packet types, for example, a first packet type 128A, a second packet type 128B, a third packet type 128C, and a fourth packet type 128D. Each packet type 128A, 128B, 128C, 128D can be different than one another, for example, in the context of syringes, the packet types 128A, 128B, 128C, 128D can each contain syringes of different sizes. Each packet type 128A, 128B, 128C, 128D can store a different type of item, for example, specimen collection swabs, empty specimen collection tubes, and vials containing fluids. In one example embodiment, packet type 128A may include syringes, packet type 128B may include specimen collection swabs, packets type 128C may include empty specimen collection tubes, and packet type 128D may include vials containing fluids. In some embodiments, two or more of the same packet type may be stored. Each feeder 108A, 108B, 108C, 108D, shuffler button 125A, 125B, 125C, 125D, and/or dispensing end 124A, 124B, 124C, 124D can be labeled to identify the type of item that is to be placed within the feeder, shuffled, and/or dispensed. The feeder, shuffler button, and/or dispensing end can be color coded and/or labeled with a text label to indicate the type of item dispensed by each portion of the dispenser 100A.

Each packet type 128A, 128B, 128C, 128D can be stored in a corresponding feeder 108A, 108B, 108C, 108D, having a respective dispensing end 124A, 124B, 124C, 124D. The feeder can include any of the features described herein with reference to feeder 108. While four feeders 108A, 108B, 108C, 108D and dispensing ends 124A, 124B, 124C, 124D are illustrated, any number of feeders 108A, 108B, 108C, 108D and dispensing ends 124A, 124B, 124C, 124D can be used, for example, one, two, three, four, five, six, or more. The feeders 108A, 108B, 108C, 108D can vary in size in order to fit within the housing 104. For example, feeders (for example, feeders 108A, 108B) that have dispensing ends (124A, 124B) positioned higher on a front wall 105 of the housing 104 may have a height H2 that is shorter than a height H3 of feeders (for example, feeders 108C, 108D) that have dispensing ends (124C, 124D) positioned lower on the front wall 105 of the housing 104. The second wall 156 of a front feeder (for example, feeders 108A, 108B) can be angled such that it corresponds to the angled first wall 152 of a back feeder (for example, feeders 108C, 108D).

Although the internal shuffler components are not shown in FIGS. 10A-10C, each dispensing end 124A, 124B, 124C, 124D and corresponding feeder 108A, 108B, 108C, 108D can be mechanically linked to a shuffler that can be activated by a button 125A, 125B, 125C, 125D. The shuffler can include any of the features described herein with reference to shuffler 116 of FIGS. 2 and 6A-6C. In some embodiments, a single shuffler can be used to shuffle more than one feeder 108A, 108B, 108C, 108D. The single shuffler can include a moveable component that extends around a front-most feeder (for example, feeder 108A) in order to reach a back-most feeder (for example, feeder 108C). In some embodiments, a single shuffler shuffling a first feeder (for example, feeder 108A) can cause the first feeder to contact a second feeder (for example, feeder 108C) causing the second feeder to move and shuffle the packets stored within. The packet dispenser 100A can be advantageous as it allows for multiple items to be dispensed from multiple feeders using one packet dispenser 100A. This can allow a user to have access to all of a plurality of items in one location.

### Example Modular Packet Dispenser

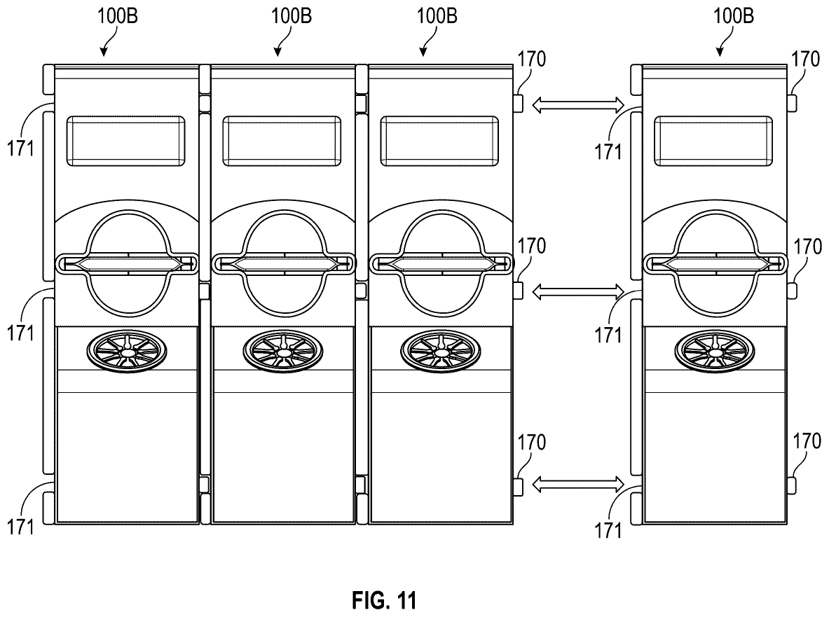

FIG. 11 is an example modular configuration of a plurality of modular packet dispensers 100B in accordance with the present disclosure. In some embodiments, each packet dispenser 100B can be filled with packets storing a different type of item relative to the other packet dispensers 100B (for example, different sizes of syringes or any other variation of any type of item). Each packet dispenser 100B can be filled with different types of items, for example, syringes of various sizes, specimen collection swabs, empty specimen collection tubes, vials containing fluid, or the like. Any combination of items can be stored in the plurality of modular packet dispensers 100B. This can allow a user to have access to the various items that the user may need in a particular setting where the packet dispensers 100B are located. The packet dispensers 100B can be mechanically coupled to secure the packet dispensers 100B to one another. For example, the packet dispensers 100B can have one or more protrusions 170 that can correspond to one or more recesses 171 in a second packet dispenser 100B. In some embodiments, the protrusions 170 can slide into the recesses 171. For example, using the orientation of the figure for description purposes only, the packet dispensers 100B can be moved in and out of the page such that the protrusions 170 slide within the recesses 171. In some embodiments, the protrusions 170 and the recesses 171 can function as a snap or friction fit and the protrusions 170 can be inserted or removed from the recesses 171 by moving the packet dispensers 100 to the right and left. The modular configuration can allow for packet dispensers 100B to be removed and replaced as needed to account for the items required to be dispensed. For example, each packet dispenser 100B can be specifically tailored for a specific type of packet (for example, due to the dimensions of the feeder or other components within the packet dispenser 100B) and each packet dispenser 100B can be interchanged as needed.

### Additional Advantages

The systems and methods described herein provide many benefits and advantages. According to embodiments of the present disclosure, the packet dispenser itself can be sold as a separate product targeting emergency and/or trauma care areas. This means there is no need for a change in existing packaging of the packets for dispensing. There is a minimal increase in cost as embodiments of the packet dispenser according to the present disclosure can be a re-usable device. Embodiments of the packet dispenser according to the present disclosure can remove the step of a user having to look for a specific type of packet, for example, the user will not have to go through multiple drawers and/or cabinets looking for the specific type of packet. Additionally, no specifical training is required to use embodiments of the packet dispenser according to the present disclosure. Further, embodiments of the packet dispenser according to the present disclosure can provide for a complete workflow from opening the packet to disposal of the packet, all of which can be supported by a single device.

### Terminology

Various modifications to the implementations described in this disclosure will be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “example” is used exclusively herein to mean “serving as an example, instance, or illustration.” Any implementation described herein as “example” is not necessarily to be construed as preferred or advantageous over other implementations, unless otherwise stated.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Additionally, other implementations are within the scope of the following claims. In some cases, the actions recited in the claims may be performed in a different order and still achieve desirable results.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

What is claimed is:

1. A packet dispenser comprising:
a feeder disposed within a housing, the feeder configured to hold a plurality of packets, the feeder comprising:
a receiving end configured to receive the plurality of packets; and
a dispensing end disposed below the receiving end, the dispensing end comprising an opening extending through the housing; and
a first cutting mechanism disposed at least partially within the opening, the first cutting mechanism configured to cut individual packets of the plurality of packets as the individual packets are removed from the dispensing end of the feeder.

2. The packet dispenser of claim 1, wherein the first cutting mechanism comprises a first protrusion having a sharp edge and a second protrusion having a sharp edge, wherein a first end of each individual packet is configured to pass between the first protrusion and the second protrusion when the individual packet is removed from the dispensing end of the feeder.

3. The packet dispenser of claim 1, further comprising a second cutting mechanism positioned at an opposite end of the opening relative to the first cutting mechanism.

4. The packet dispenser of claim 1, further comprising a shuffler configured to shuffle the plurality of packets within the feeder, wherein the shuffling of the plurality of packets assists at least one of the plurality of packets to move toward the dispensing end.

5. The packet dispenser of claim 4, wherein the shuffler comprises a button disposed at an exterior of the housing and mechanically linked to at least one actuator within the feeder.

6. The packet dispenser of claim 5, wherein depressing the button causes the at least one actuator to lift one or more other packets within the feeder to allow the at least one of the plurality of packets to move toward the dispensing end.

7. The packet dispenser of claim 1, wherein the receiving end of the feeder comprises an opening having a length greater than or equal to a length of each individual packet and a width shorter than the length of each individual packet.

8. The packet dispenser of claim 1, further comprising a waste drawer configured to receive a portion of the packet removed when the first cutting mechanism cuts one of the plurality of packets.

9. The packet dispenser of claim 1, wherein the opening of the dispensing end has a recessed area positioned between two lateral ends, wherein the first cutting mechanism is disposed within one of the lateral ends.

10. The packet dispenser of claim 1, wherein the packet dispenser further comprises:
a second feeder disposed within the housing, the second feeder configured to hold a second plurality of packets, the second feeder comprising:
a receiving end configured to receive the second plurality of packets; and
a dispensing end disposed below the receiving end, the dispensing end comprising a second opening extending through the housing; and
a second cutting mechanism disposed at least partially within the second opening, the second cutting mechanism configured to open individual packets of the second plurality of packets as the individual packets are removed from the dispensing end of the second feeder.

11. A packet dispenser comprising:
a feeder disposed within a housing, the feeder configured to receive a plurality of packets in a predetermined orientation and feed the plurality of packets toward a dispensing end of the feeder; and
a first cutting mechanism and a second cutting mechanism disposed within an opening of the dispensing end of the feeder, the first cutting mechanism positioned at an opposite end of the opening relative to the second cutting mechanism, the first cutting mechanism configured to cut a first end of individual packets of the plurality of packets as the individual packets are removed from the dispensing end of the feeder, the second cutting mechanism configured to cut a second end of the individual packets of the plurality of packets as the individual packets are removed from the dispensing end of the feeder.

12. The packet dispenser of claim 11, wherein the opening of the dispensing end has a recessed area positioned between two lateral ends, wherein the first cutting mechanism is disposed within a first of the lateral ends and the second cutting mechanism is disposed within a second of the lateral ends.

13. The packet dispenser of claim 11, wherein the first cutting mechanism comprises a first protrusion having a sharp edge and a second protrusion having a sharp edge, wherein the first end of each individual packet of the plurality of packets is configured to pass between the first protrusion and the second protrusion when the individual packet is removed from the dispensing end.

14. The packet dispenser of claim 13, wherein the second cutting mechanism comprises a first protrusion having a sharp edge and a second protrusion having a sharp edge, wherein the second end of each individual packet of the plurality of packets is configured to pass between the first protrusion and the second protrusion when the individual packet is removed from the dispensing end.

15. The packet dispenser of claim 11, further comprising a shuffler configured to shuffle the plurality of packets within the feeder, wherein the shuffling of the plurality of packets assists at least one of the plurality of packets to move toward the dispensing end.

16. The packet dispenser of claim 15, wherein the shuffler comprises a button disposed at an exterior of the housing and mechanically linked to at least one moveable component within the feeder.

17. The packet dispenser of claim 16, wherein depressing the button causes the at least one moveable component to lift one or more other packets within the feeder to allow the at least one of the plurality of packets to move toward the dispensing end.

18. The packet dispenser of claim 11, wherein a receiving end of the feeder comprises an opening having a length greater than or equal to a length of each individual packet and a width shorter than the length of each individual packet.

19. The packet dispenser of claim 11, further comprising a first waste drawer configured to receive a first portion of the individual packet removed when the first cutting mechanism cuts the first end of the individual packets of the plurality of packets, and a second waste drawer configured to receive a second portion the individual packet removed when the second cutting mechanism cuts the second end of the individual packets of the plurality of packets.

20. The packet dispenser of claim 1, wherein the plurality of packets each contain a sterilized item.

21. A method of dispensing a packet comprising:
directing a plurality of packets to a dispensing end of a packet dispenser by receiving the plurality of packets into a feeder positioned in a housing of the packet dispenser, wherein the plurality of packets move from a receiving end of the feeder to the dispensing end of the feeder;
exposing a portion of one of the plurality of packets extending at least partially out of an opening at the dispensing end of the feeder; and
cutting at least one end of the one of the plurality of packets as the at least one end passes through a cutting mechanism disposed within the opening of the dispensing end.

22. The method of claim 20, further comprising shuffling the plurality of packets within the feeder in response to a button coupled to a shuffler disposed within the housing being depressed.

23. The method of claim 20, further comprising cutting a second end of the one of the plurality of packets as the second end passes through a second cutting mechanism disposed within the opening of the dispensing end.

24. The method of claim 20, wherein directing the plurality of packets to the dispensing end further comprises constraining the plurality of packets to a first orientation configured to align with an opening of the receiving end.
